(19) United States
(12) Patent Application Publication
(10) Pub. No.: US 2004/0184102 A1
(43) Pub. Date: Sep. 23, 2004

(54) Image forming apparatus

(75) Inventor: Teruyuki Hiyoshi, Tagata-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: TOSHIBA TEC KABUSHIKI KAISHA, Tokyo (JP)

(21) Appl. No.: 10/390,405

(22) Filed: Mar. 17, 2003

(51) Int. Cl. G06F 15/00

(52) U.S. Cl. 358/1.16; 358/1.17

(57) ABSTRACT

An image forming apparatus in accordance with the present invention includes: at least two image memories in which image data is stored; a printing unit that executes a printing action for paper, which is a recording medium, on the basis of image data; and a control unit that inputs image data selectively in the two image memories and that transfers image data selectively from the two image memories to the printing unit. While the control unit transfers image data from one of the two image memories to the printing unit, the control unit inputs image data in the other one of the two image memories. During a printing action, preparations for the next printing action are completed. Occurrence of a standby time during continuous printing or the like can therefore be prevented. Eventually, the start of the next printing action can be advanced.

### BACKGROUND OF THE INVENTION

1. Field of the Invention

The present invention relates to an image forming apparatus that forms an image on a recording medium.

2. Discussion of the Background

Various types of image forming apparatuses including a printer, a copier, and a complex machine (multifunction peripheral (MFP)) have been developed as image forming apparatuses that form an image on a recording medium, and have prevailed among a wide range of fields. The image forming apparatus includes an image memory or the like in which image data is stored. Generally, image data received from an external apparatus (for example, a personal computer) is preserved in the image memory. Moreover, Japanese Patent Application Publication No. 04-001076 has proposed a technology for backing up data, which is preserved in one memory, in another memory.

FIG. 2 is a block diagram schematically showing electric connections in a conventional image forming apparatus 100. The image forming apparatus 100 is constituted such that a printing unit 101, a central processing unit (CPU) 102, a read only memory (ROM) 103, a random access memory (RAM) 104, a communication interface 105, an image memory 106, a printing address producing circuit 107, and a plurality of switching circuits 108a, 108b, and 108c are interconnected over a bus 109. The printing unit 101 executes, for example, an action of printing an image on paper that is a recording medium. The CPU 102 controls respective components on a centralized basis. Various control programs to be run by the CPU 102 are stored in the ROM 103. The RAM 104 serves as a work area for the CPU 102. The communication interface 105 receives image data from an external apparatus. Received image data is stored in an image memory 106. The printing address producing circuit 107 produces a printing address based on which image data is transferred from the image memory 106 to the printing unit 101. In FIG. 2, a solid line indicates an address bus, and a dot-dash line indicates a data bus. A dashed line indicates a control line over which the plurality of switching circuits 108a, 108b, and 108c is controlled. The printing unit 101 includes, for example, an ink-jet head that jets out ink through a nozzle thereof in the form of ink droplets.

In relation to the foregoing components, inputting (writing) image data to the image memory 106 will be described. The CPU 102 notifies the printing address producing circuit 107 that image data will be inputted in the image memory 106. In response to the notification from the CPU 102, the printing address producing circuit 107 switches address outputs of the switching circuit 108a so that an address based on which image data is inputted in the image memory 106 will be adopted. At the same time, the printing address producing circuit 107 validates the switching circuit 108b (makes the data bus on which the switching circuit 108b is connected), and invalidates the switching circuit 108c (breaks the data bus on which the switching circuit 108c is connected). This brings the image memory 106 to a state in which the image memory 106 appears to be connected to the CPU 102. The CPU 102 inputs image data in the predetermined address in the image memory 106, and thus writes the image data in the image memory 106.

Next, transferring (reading) image data to the printing unit 101 will be described below. The CPU 102 notifies the printing address producing circuit 107 that image data will be transferred from the image memory 106 to the printing unit 101. The printing address producing circuit 107 switches address outputs of the switching circuit 108a so that a produced printing address will be adopted. At the same time, the printing address producing circuit 107 invalidates the switching circuit 108b (breaks the data bus on which the switching circuit 108b is connected), and validates the switching circuit 108c (makes the data bus on which the switching circuit 108c is connected). This brings the image memory 106 to a state in which the image memory 106 appears to be connected to the printing unit 101 and printing address producing circuit 107. The printing address producing circuit 107 produces a printing address at a predetermined timing. Based on the printing address, the CPU 102 continuously transfers image data, which has been inputted (written) in the image memory 106, to the printing unit 101.

However, in the foregoing image forming apparatus 100, while image data is transferred from the image memory 106 to the printing unit 101, the image memory 106 is under the control of the printing address producing circuit 107. Unless transferring the image data from the image memory 106 is completed, the CPU 102 cannot input image data in the image memory 106. Consequently, in the conventional image forming apparatus 100, while image data is transferred from the image memory 106 to the printing unit 101, the next image data cannot be inputted in the image memory 106. After transferring image data is completed, that is, after printing is completed, the CPU 102 inputs image data in the image memory 106. Moreover, while the CPU 102 is inputting image data in the image memory 106, the printing unit 101 cannot execute a printing action. Namely, inputting image data in the image memory 106 and transferring image data from the image memory 106 to the printing unit 101 cannot be executed simultaneously. Eventually, a standby time occurs during continuous printing or the like. This poses a problem in that the start of the next printing action is delayed.

### SUMMARY OF THE INVENTION

Accordingly, an object of the present invention is to provide an image forming apparatus capable of preventing occurrence of a standby time during continuous printing or the like.

The object of the present invention is accomplished with a novel image forming apparatus in accordance with the present invention.

Consequently, the novel image forming apparatus in accordance with the present invention includes: at least two image memories in which image data is stored; a printing unit that executes a printing action for a recording medium on the basis of image data; and a control unit that inputs image data selectively in the two image memories, and transfers image data selectively from the two image memories to the printing unit. While the control unit is transferring image data from one of the two image memories to the printing unit, the control unit inputs image data in the other one of the two image memories.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram schematically showing electric connections in an image forming apparatus in accordance with an embodiment of the present invention; and

FIG. 2 is a block diagram schematically showing electric connections in a conventional image forming apparatus.

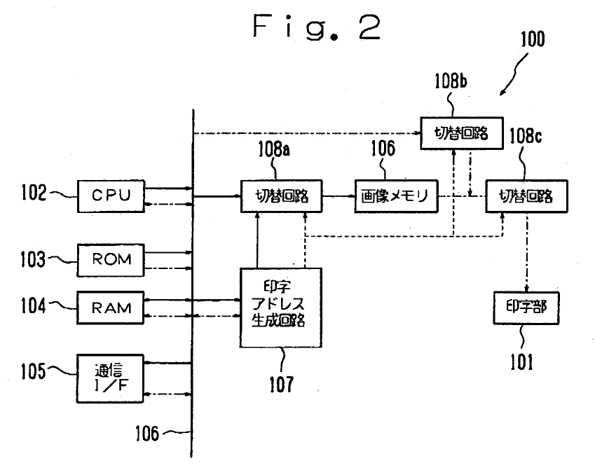

### DETAILED DESCRIPTION OF THE PREFERRED EMBODIMENT

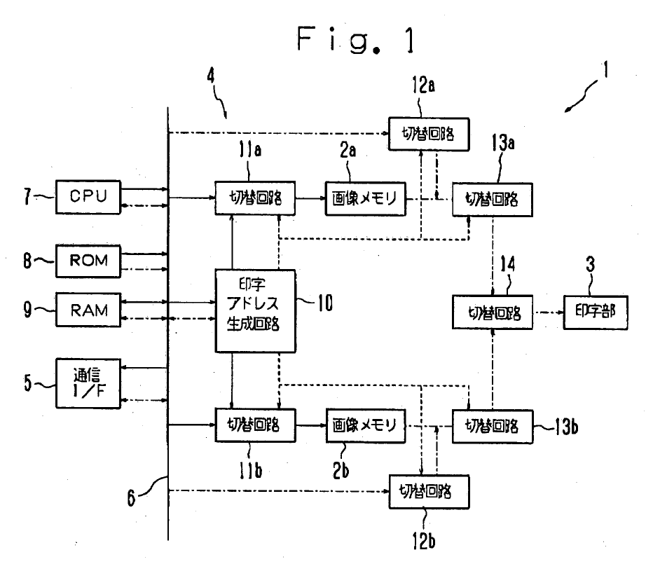

An embodiment of the present invention will be described in conjunction with the drawings. FIG. 1 is a block diagram schematically showing electric connections in an image forming apparatus.

An image forming apparatus 1 is constituted such that two image memories 2a and 2b, a printing unit 3, a control unit 4, and a communication interface 5 are interconnected over a bus 6. Image data is stored in the two image memories 2a and 2b. The printing unit 3 executes a printing action of printing image on paper or any other recording medium on the basis of image data. The control unit 4 drives and controls the printing unit 3. The communication interface 5 receives image data from an external apparatus (for example, a personal computer). Herein, the control unit 4 inputs image data selectively in the two image memories 2a and 2b, and transfers image data selectively from the two image memories 2a and 2b to the printing unit 3.

The control unit 4 is constituted such that a central processing unit (CPU) 7, a read only memory (ROM) 8, a random access memory (RAM), a printing address producing circuit 10, and a plurality of switching circuits 11a, 11b, 12a, 12b, 13a, 13b, and 14 are interconnected over the bus 6. The CPU 7 controls the respective components on a centralized basis. Various control programs to be run by the CPU 7 are stored in the ROM 8. The RAM 9 serves as a work area for the CPU 7. The printing address producing circuit 10 produces a printing address based on which image data is transferred from the image memory 2a or 2b to-the printing unit 3. Incidentally, in FIG. 1, a solid line indicates an address bus or the like, a dot-dash line indicates a data bus, and a dashed line indicates a control line over which the plurality of switching circuits is controlled.

The printing unit 3 has, for example, an ink-jet head that jets out ink through a nozzle thereof in the form of ink droplets. For example, a nonvolatile EEPROM or RAM is adopted as the image memories 2a and 2b. Moreover, for example, predetermined image data is stored in the image memory 2b. The predetermined image data may be a printing pattern used to observe the characteristic of an ink-jet head concerning jetting of ink through a nozzle or a printing pattern used for maintenance.

The printing address producing circuit 10 produces a printing address based on which image data is transferred from the image memories 2a and 2b to the printing unit 3. Furthermore, the printing address producing circuit 10 controls the plurality of switching circuits 11a, 11b, 12a, 12b, 13a, 13b, and 14.

The switching circuit 11a is connected among the CPU 7, image memory 2a, and printing address producing circuit 10 over the address bus. Based on a control signal sent from the printing address producing circuit 10, the switching circuit 11a switches an address based on which image data is inputted in the image memory 2a and a printing address based on which image data is transferred from the image memory 2a to the printing unit 3. Likewise, the switching circuit 11b is connected among the CPU 7, image memory 2b, and printing address producing circuit 10 over the address bus. Based on a control signal sent from the printing address producing circuit 10, the switching circuit 11b switches an address based on which image data is inputted in the image memory 2b and a printing address based on which image data is transferred from the image memory 2b to the printing unit 3.

The switching circuit 12a is connected between the CPU 7 and image memory 2a over the data bus, and switches connection/disconnection of the data bus according to a control signal sent from the printing address producing circuit 10. Likewise, the switching circuit 12b is connected between the CPU 7 and image memory 2b over the data bus, and switches connection/disconnection of the data bus according to a control signal sent from the printing address producing circuit 10.

The switching circuit 13a is connected between the image memory 2a and switching circuit 14 over the data bus, and switches connection/disconnection of the data bus according to a control signal sent from the printing address producing circuit 10. Likewise, the switching circuit 13b is connected between-the image-memory 2b and switching circuit 14 over the data bus, and switches connection/disconnection of the data bus according to a control signal sent from the printing address producing circuit 10.

The switching circuit 14 is connected between the switching circuits 13a and 13b, and switches connection/disconnection of the data bus according to a control signal sent from the printing address producing circuit 10. Thus, either image data inputted in the image memory 2a or image data inputted in the image memory 2b is transferred to the printing unit 3.

In relation to the foregoing components, inputting image data in the image memory 2a will be described below. The CPU 7 notifies the printing address producing circuit 10 that image data will be inputted in the image memory 2a (for example, the CPU 7 transmits a notifying signal to the printing address producing circuit 10). In response to the notification sent from the CPU 7, the printing address producing circuit 10 switches address outputs of the switching circuit 11a so that an address based on which image data is inputted in the image memory 2a will be adopted. At the same time, the printing address producing circuit 10 validates the switching circuit 12a (makes the data bus on which the switching circuit 2a is connected), and invalidates the switching circuit 13a (breaks the data bus on which the switching circuit 13a is connected). This brings the image memory 2a to a state in which the image memory 2a appears to be connected to the CPU 7. The CPU 7 inputs image data in the predetermined address in the image memory 2a, and thus writes the image data in the image memory 2a.

Next, transferring image data from the image memory 2a to the printing unit 3 will be described below. After the CPU 7 completes writing image data in the image memory 2a, the CPU 7 notifies the printing address producing circuit 10 that image data will be transferred from the image memory 2a to the printing unit 3 (for example, the CPU 7 transmits a notifying signal to the printing address producing circuit). The printing address producing circuit 10 switches address outputs of the switching circuit 11a so that a produced printing address will be adopted. At the same time, the printing address producing circuit 10 invalidates the switching circuit 12a (breaks the data bus on which the switching circuit 12a is connected), and validates the switching circuit 13a (makes the data bus on which the switching circuit 13a is connected). Furthermore, the printing address producing circuit 10 controls the switching circuit 14 so that the printing circuit 3 will receive image data transferred from the image memory 2a. This brings the image memory 2a to a state in which the image memory 2a appears to be connected to the printing address producing circuit 10. The printing address producing circuit 10 produces a printing address at a predetermined timing. Based on the printing address, the CPU 7 continuously transfers image data, which is inputted in the image memory 2a, to the printing unit 3.

Next, a description will be made of a case where while image data is transferred from the image memory 2a to the printing unit 3, other image data is inputted in the image memory 2b.

Based on a printing address produced at a predetermined timing by the printing address producing circuit 10, the CPU 7 continuously transfers image data, which is inputted in the image memory 2a, to the printing output 3.

In this state, the CPU 7 notifies the printing address producing circuit 10 that image data will be inputted in the image memory 2b (for example, the CPU 7 transmits a notifying signal to the printing address producing circuit). In response to the notification sent from the CPU 7, the printing address producing circuit 10 switches address outputs of the switching circuit 11b so that an address based on which image data is inputted in the image memory 2b will be adopted. At the same time, the printing address producing circuit 10 validates the switching circuit 12b (makes the data bus on which the switching circuit 12b is connected), and invalidates the switching circuit 13b (breaks the data bus on which the switching circuit 13b is connected). This brings the image memory 2b to a state in which the image memory appears to be connected to the CPU 7. The CPU 7 inputs image data in the predetermined address in the image memory 2b, and thus writes the image data in the image memory 2b. Thus, while image data is transferred from the image memory 2a to the printing unit 3, other image data is inputted in the image memory 2b.

Thereafter, the printing address producing circuit 10 confirms that transferring image data from the produced printing address in the image memory 2a is completed. The printing address producing circuit 10 then controls the switching circuit 14 so that the printing unit 3 will receive the image data transferred from the image memory 2b. This brings the image memory 2b to a state in which the image memory 2b appears to be connected to the printing address producing circuit 10. The printing address producing circuit 10 produces a printing address at a predetermined timing. Based on the printing address, the CPU 7 continuously transfers the image data, which is inputted in the image memory 2b, to the printing unit 3.

The procedure of transferring image data from the image memory 2b to the printing unit 3 and inputting other image data in the image memory 2a in the meantime is basically identical to the aforesaid one. The description of the procedure will therefore be omitted.

As mentioned above, the present embodiment includes: the at least two image memories 2a and 2b in which image data is stored; the printing unit 3 that executes a printing action for a recording medium according to image data; and the control unit 4 that inputs image data selectively in the two image memories 2a and 2b, and transfers image data selectively from the two image memories 2a and 2b to the printing unit 3. While the control unit 4 is transferring image data from one of the two image memories 2a and 2b to the printing unit 3, the control unit 4 inputs image data in the other one of the two image memories 2a and 2b. During a printing action, preparations for the next printing action are completed. Occurrence of a standby time during continuous printing or the like can therefore be prevented. Eventually, the start of the next printing action can be advanced.

Moreover, printing an image represented by a large amount of data requires an image memory whose storage capacity is large enough to store the large amount of image data. According to the present invention, two image memories each having a small storage capacity are included (for example, the image memories 2a and 2b). The large amount of image data is inputted alternately in the two image memories 2a and 2b having the small storage capacity, and the inputted image data is transferred alternately from the image memories to the printing unit 3. This obviates the necessity of replacing an existing small-capacity image memory with a large-capacity image memory. Another small-capacity image memory should merely be included additionally. Consequently, reduction in costs is realized.

Moreover, according to the present embodiment, predetermined image data is stored-in advance in one of the two image memories 2a and 2b. While the control unit 4 is transferring the predetermined image data from the image memory 2b, in which the predetermined image data is stored, to the printing unit 3, the control unit 4 inputs other image data in the image memory 2a in which the predetermined image data is not stored. Consequently, other image data can be inputted in the image memory 2a in the course of printing a predetermined image pattern (for example, a printing pattern for maintenance). While an action of printing the predetermined image pattern is under way, preparations for the next printing action are completed. Therefore, occurrence of a standby time during continuous printing or the like can be prevented. Eventually, the start of the next printing action can be advanced.

Obviously, numerous modifications and variations of the present invention are possible in light of the above teachings. It is therefore to be understood that within the scope of the appended claims, the invention may be practiced otherwise than as specifically described herein.

What is claimed is:

1. An image forming apparatus comprising:
at least two image memories in which image data is stored;
a printing unit that executes a printing action for a recording medium on the basis of the image data; and
a control unit that inputs image data selectively in the two image memories and that transfers image data selectively from the two image memories to the printing unit, wherein:
while the control unit is transferring image data from one of the two image memories to the printing unit, the control unit inputs image data in the other one of the two image memories.

2. An image forming apparatus according to claim 1, wherein:
predetermined image data is stored in advance in one of the two image memories; and
while the control unit is transferring the predetermined image data from the image memory in which the predetermined image data is stored, the control unit inputs other image data in the image memory in which the predetermined image data is not stored.
